(19) United States
(12) Patent Application Publication
(10) Pub. No.: US 2025/0233793 A1
(43) Pub. Date: Jul. 17, 2025

(54) DEVICE MANAGEMENT SYSTEM AND METHOD

(71) Applicant: CANON KABUSHIKI KAISHA, Tokyo (JP)

(72) Inventor: TOSHIO OHASHI, Tokyo (JP)

(21) Appl. No.: 18/983,132

(22) Filed: Dec. 16, 2024

(30) Foreign Application Priority Data
Jan. 17, 2024 (JP) 2024-005674

(51) Int. Cl. H04L 41/0654; H04L 41/0631

(52) U.S. Cl. CPC H04L 41/0654; H04L 41/0631

(57) ABSTRACT

A device management system includes: a treatment information acquiring unit configured to acquire treatment information indicating information on a treatment on the basis of a diagnosis result for each of a plurality of treatments; an accessibility information acquiring unit configured to acquire accessibility information indicating whether a user is able to access the treatment; a supportability information acquiring unit configured to acquire supportability information indicating whether the network device is supported by a treatment; a treatment implementability determining unit configured to determine whether the treatment is implementable on the basis of at least one of the accessibility information and the supportability information; and a display unit configured to display the treatment when it is determined that the treatment is implementable.

### BACKGROUND OF THE INVENTION

### Field of the Invention

The present invention relates to a device management system and a method.

### Description of the Related Art

Recently, systems for remotely diagnosing and repairing a network device have been increasingly used with the evolution of cloud computing and the Internet of Things (IoT) technology. A general flow from occurrence of a problem in a network device to solution thereto is often carried out in the order of detection of a problem, diagnosis of reasons, treatment based on the diagnosis result, and verification of whether the network device has been restored normally. Here, with a focus on treatment based on the diagnosis result, for example, a technique disclosed in Japanese Unexamined Patent Publication No. 2023-2420 is known as a technique of determining whether treatment for restoration is remotely implementable in the related art. This technique is to determine accessibility on the basis of network device state information and access right rules which are constantly updated.

The treatment for restoring a network device from a problem may include a plurality of unit which are remotely implementable. Remote treatment which is optimal for a user differs according to familiarity, a degree of desire of use, accessibility to treatment, treatability a target network device, whether an owner of the network device agrees to implementation of remote treatment, and the like. Accordingly, in consideration of the aforementioned circumstances, it is necessary to determine and display remote treatment which is optimal for a user and to guide the user to the optimal remote treatment. However, such a technique is not known in the related art.

### SUMMARY OF THE INVENTION

Therefore, an objective of the present invention is to provide a device management system and a method that can determine and display a remote treatment which is optimal for a user on the basis of accessibility to treatment, whether an owner of a network device agrees to implementation of treatment, whether a treatment is supported by a network device, and the like and enable guidance to optimal remote treatment.

A device management system according to the present invention is a device management system that diagnoses a problem associated with a network device on the basis of information acquired from the network device and displays a treatment for the problem on the basis of a diagnosis result, the device management system including: a treatment information acquiring unit configured to acquire treatment information indicating information on the treatment on the basis of the diagnosis result for each of a plurality of treatments; an accessibility information acquiring unit configured to acquire accessibility information indicating whether a user is able to access the treatment; a supportability information acquiring unit configured to acquire supportability information indicating whether the network device is supported by the treatment; a treatment implementability determining unit configured to determine whether the treatment is implementable on the basis of at least one of the accessibility information and the supportability information; and a display unit configured to display the treatment when it is determined that the treatment is implementable.

Further features of the present invention will become apparent from the following description of exemplary embodiments with reference to the attached drawings.

### BRIEF DESCRIPTION OF THE DRAWINGS

FIG. 1 is a diagram illustrating a hardware configuration of a device management system according to a first embodiment and a second embodiment.

FIG. 2 is a diagram illustrating a software configuration according to the first embodiment.

FIG. 3A is a diagram illustrating a network device management table and a log management table according to the first embodiment.

FIG. 3B is a diagram illustrating a diagnosis logic management table and a treatment logic management table according to the first embodiment.

FIG. 3C is a diagram illustrating a treatment unit management table and a treatment logic-treatment unit correlation management table according to the first embodiment.

FIG. 3D is a diagram illustrating user management table according to the first embodiment.

FIG. 4 is a flowchart illustrating a process flow at the time of determining and displaying a remote treatment unit according to the first embodiment.

FIG. 5 is a diagram illustrating an example of a treatment unit selection screen according to the first embodiment.

FIG. 6 is a diagram illustrating an example of a diagnosis result display screen (a customer manager) according to the first embodiment.

FIG. 7 is a diagram illustrating an example of a diagnosis result display screen (a call center operator) according to the first embodiment.

FIG. 8 is a diagram illustrating an example of a diagnosis result display screen (a service technician) according to the first embodiment.

FIG. 9A is a diagram illustrating a network device management table and a log management table according to a second embodiment.

FIG. 9B is a diagram illustrating a diagnosis logic management table and a treatment logic management table according to the second embodiment.

FIG. 9C is a diagram illustrating a treatment unit management table and a treatment logic-treatment unit correlation management table according to the second embodiment.

FIG. 9D is a diagram illustrating user management table according to the second embodiment.

FIG. 10 is a flowchart illustrating a process flow at the time of determining and displaying a remote treatment unit according to the second embodiment.

FIG. 11 is a diagram illustrating an example of a diagnosis result display screen (a service technician) according to the second embodiment.

FIG. 12 is a diagram illustrating an example of a treatment target device selection screen according to the second embodiment.

### DESCRIPTION OF THE EMBODIMENTS

Hereinafter, embodiments of the present invention will be described with reference to the accompanying drawings.

A device management system according to an embodiment diagnoses a problem associated with a network device on the basis of information acquired from the network device and displays a treatment for the problem on the basis of a diagnosis result. The device management system according to the embodiment includes a treatment information acquiring unit, an accessibility information acquiring unit, a supportability information acquiring unit, a treatment implementability determining unit, and a display unit. The treatment information acquiring unit acquires treatment information indicating information on the treatment on the basis of the diagnosis result for each of a plurality of treatments. The accessibility information acquiring unit acquires accessibility information indicating whether a user is able to access the treatment. The supportability information acquiring unit acquires supportability information indicating whether the network device is supported by the treatment. The treatment implementability determining unit determines whether the treatment is implementable on the basis of at least one of the accessibility information and the supportability information. The display unit displays the treatment when it is determined that the treatment is implementable.

The device management system according to the embodiment may further include a use agreement information acquiring unit configured to use agreement information indicating whether an owner of the network device agrees to use of the treatment. In this case, the treatment implementability determining unit determines whether the treatment is implementable on the basis of the use agreement information.

The device management system according to the embodiment may further include a treatment unit configured to transmit an instruction for at least one of change of device settings and restart based on the diagnosis result to the network device via a network as one of the plurality of treatments. Accordingly, the treatment unit copes with the problem associated with the network device.

In the device management system according to the embodiment, one of the plurality of treatments may include remote access to an operation unit of the network device. Accordingly, the device management system copes with the problem associated with the network device.

The supportability information acquiring unit may further acquire multi-device treatability information indicating whether the treatment is able to be simultaneously implemented on the plurality of network devices. In this case, the treatment implementability determining unit determines whether the treatment is implementable on the basis of the multi-device treatability information.

The display unit may determine whether the treatment includes a unit for verification after implementation of the treatment has been completed and preferentially display the treatment when it is determined that the treatment includes the unit for verification after implementation of the treatment has been completed.

The display unit may determine whether the treatment includes a unit for verification after implementation of the treatment has been completed and display the unit for verification after implementation of the treatment has been completed along with the treatment when it is determined that the treatment does not include the unit for verification after implementation of the treatment has been completed.

Hereinafter, exemplary embodiments of the present invention will be described with reference to the accompanying drawings.

### First Embodiment

A first embodiment of the device management system according to the present invention will be described below. In the first embodiment, an example in which the device management system is realized by a web application that operates in a cloud will be described. In the first embodiment, a multifunction peripheral (MFP) will be described as an example of a network device to be diagnosed by the device management system. The network device may be a device such as a printer or a facsimile other than a multifunction peripheral.

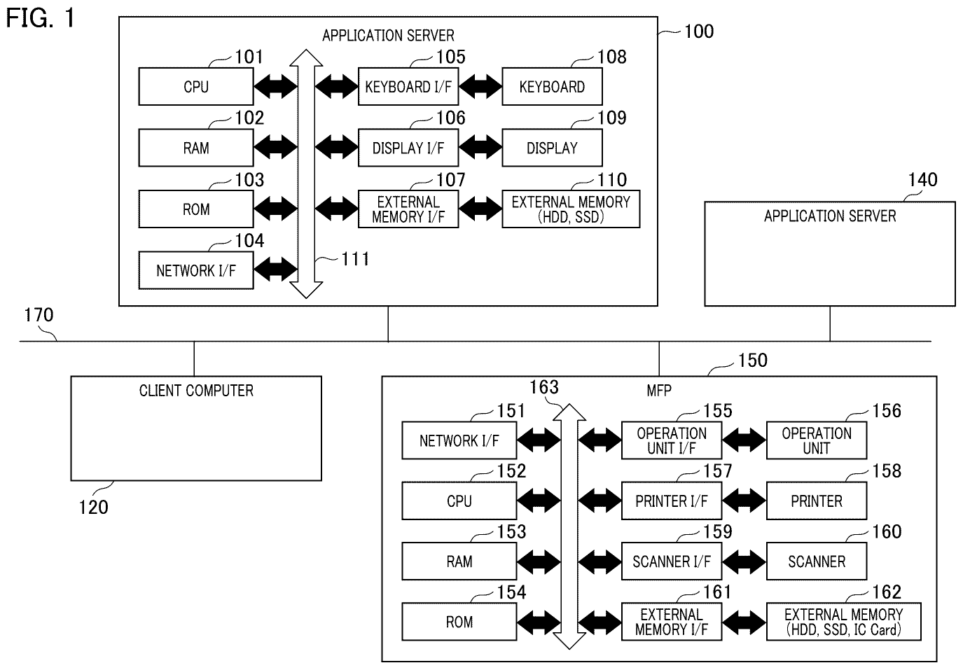

FIG. 1 is a diagram illustrating a hardware configuration of the device management system according to the first embodiment and a second embodiment. As illustrated in FIG. 1, the device management system includes an application server 100, a client computer 120, an application server 140, and an MFP 150 which are connected via a network 170. The application server 100 is realized, for example, by a general-purpose computer which is realized using hardware resources supplied on demand through virtualization technology. The client computer 120 and the application server 140 are realized by general-purpose computers.

The application server 100 includes a central processing unit (CPU) 101, a random access memory (RAM) 102, and a read only memory (ROM) 103 as illustrated in FIG. 1. As illustrated in FIG. 1, the application server 100 includes a network I/F 104, a keyboard I/F 105, a display I/F 106, and an external memory I/F 107. As illustrated in FIG. 1, the application server 100 includes a keyboard 108, a display 109, and an external memory 110.

The CPU 101 performs processes on the basis of an application program or the like stored in the ROM 103 or the external memory 110. The CPU 101 comprehensively controls devices connected to a system bus 111. The CPU 101 opens various registered windows on the basis of commands instructed via a mouse cursor or the like (not illustrated) on the display 109 and performs processing of various types of data.

The RAM 102 serves as a main memory, a work area, or the like of the CPU 101. The ROM 103 is a read-only memory serving as a storage area of a basic I/O program or the like. An operating system (OS) program (hereinafter referred to as an OS) which is a control program of the CPU 101 or the like is stored in the ROM 103 or the external memory 110. Files used for processing based on the application program or the like or various types of other data are stored in the ROM 103 or the external memory 110.

The network I/F 104 connects the application server 100 to the network 170 and performs network communication. The keyboard I/F 105 controls inputting from the keyboard 108 or a pointing device which is not illustrated. The display I/F 106 controls display of the display 109. The external memory I/F 107 controls access of a hard disk drive (HDD), a solid state drive (SSD), or the like to the external memory 110.

The external memory 110 stores a booting program, various types of applications, a user file, an editing file, and the like. The application server 100 operates in a state in which the CPU 101 is executing the basic I/O program and the OS stored in the ROM 103 or the external memory 110. The basic I/O program is stored in the ROM 103. The OS is stored in the ROM 103 or the external memory 110. When a computer is powered on, the OS is loaded to the RAM 102 from the ROM 103 or the external memory 110 using an initial program loading function of the basic I/O program, and operation of the OS is started.

The system bus 111 connects the devices. Hardware resources such as the CPU 101, the ROM 103, and the external memory 110 constituting the application server 100 are supplied on demand through virtualization technology. When these hardware resources are supplied on demand through virtualization technology, the application server 100 is configured as a virtual server in a cloud computing environment.

The hardware configurations of the client computer 120 and the application server 140 are the same as the application server 100, and thus description thereof will be omitted.

The MFP 150 includes a network I/F 151, a CPU 152, a RAM 153, and a ROM 154 as illustrated in FIG. 1. As illustrated in FIG. 1, the MFP 150 includes an operation unit I/F 155, a printer I/F 157, a scanner I/F 159, and an external memory I/F 161. As illustrated in FIG. 1, the MFP 150 includes an operation unit 156, a printer 158, a scanner 160, and an external memory 162.

The network I/F 151 connects the MFP 150 to the network 170 and performs network communication. The CPU 152 outputs an image signal which is output information to the printer 158 via the printer I/F 157 connected to the system bus 163 on the basis of a control program or the like. The control program is stored in the ROM 154, the external memory 162, or the like. The CPU 152 is configured to perform a communication process with a computer via the network I/F 151 and to notify the application server 100 or the application server 140 of information or the like in the MFP 150. The CPU 152 performs processes on the basis of an application program or the like stored in the ROM 154 or the external memory 162.

The RAM 153 serves as a main memory, a work area, or the like of the CPU 152 and is configured to extend a memory capacity using an optional RAM connected to an extension port which is not illustrated. The RAM 153 is used as an output information development area, an environment data storage area, a non-volatile RAM (NVRAM), or the like. The control program of the CPU 152, an application program, font data used to generate the output information, information used in the MFP 150, or the like is stored in the ROM 154 or the external memory 162. The external memory 162 is, for example, an HDD.

The operation unit I/F 155 is an interface with the operation unit 156 and outputs image data to be displayed to the operation unit 156. The operation unit I/F 155 receives information which is input by allowing a user to operate the operation unit 156. The operation unit 156 is, for example, an operation panel in which a switch for operation, a light-emitting diode (LED) indicator, and the like are arranged.

The printer I/F 157 outputs an image signal which is output information to the printer 158 (a printer engine). The scanner I/F 159 receives an image signal which is input information from the scanner 160 (a scanner engine). The external memory I/F 161 is a memory controller and controls access to an external memory 162 such as an HDD or an IC card. The number of external memories 162 is not limited to one, at least one external memory may be provided, and a plurality of external memories may be connected. The external memory 162 may include an NVRAM which is not illustrated and store printer mode setting information from the operation unit 156. The system bus 163 connects the devices.

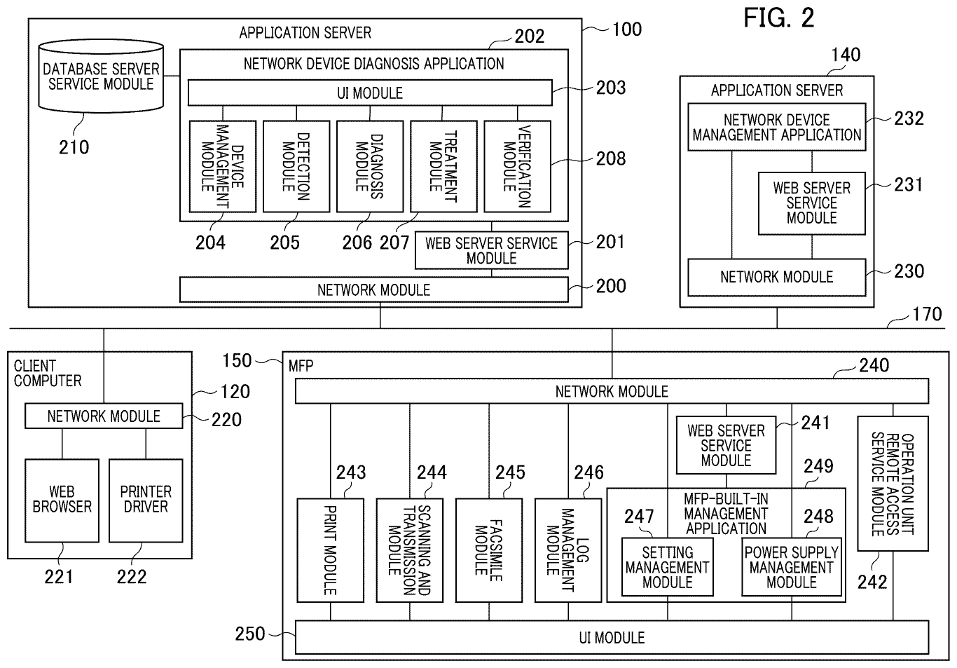

FIG. 2 is a diagram illustrating a software configuration according to the first embodiment. As illustrated in FIG. 2, the application server 100 includes a network device diagnosis application 202, a network module 200, and a web server service module 201.

The network device diagnosis application 202 and modules included therein are present as files stored in the external memory 110. These are program modules which are loaded to the RAM 102 and implemented by the OS or a module using modules included in the OS or the network device diagnosis application 202 at the time of implementation. The network device diagnosis application 202 can be added to the HDD or the SSD of the external memory 110, which is supplied on demand through virtualization technology in the cloud computing environment.

The network module 200 performs network communication with the client computer 120 or the MFP 150 using arbitrary communication protocol. The web server service module 201 provides a service of returning a hypertext transfer protocol (HTTP) response when an HTTP request from a web browser 221 of the client computer 120 is received. The web server service module 201 may return web page data stored in the external memory 110 as an example of the HTTP response to be returned. Alternatively, the web server service module 201 may request a user interface (UI) module 203 of the network device diagnosis application 202 to generate an HTTP response.

The network device diagnosis application 202 is an application of detecting occurrence of a problem in the MFP 150 connected to the application server 100 via the network 170 and performing diagnosis, treatment, and verification. The network device diagnosis application 202 is mounted, for example, as a program for performing processes in response to a request to a web page which is provided by the web server service module 201. As described above, the network device diagnosis application 202 along with the web server service module 201 realizes a web application of detecting occurrence of a problem in the MFP 150 and performing diagnosis, treatment, and verification.

The UI module 203 generates an HTTP response in response to a request from the web server service module 201. The UI module 203 receives user input information which is transmitted from the web browser 221 of the client computer 120 and calls the modules according to necessity.

Examples of the modules called by the UI module 203 include a device management module 204, a detection module 205, a diagnosis module 206, a treatment module 207, and a verification module 208. Here, the UI module 203 may call a module other than described above. The device management module 204 acquires device information or a log from the MFP 150 connected to the application server 100 via the network 170 via the network module 200. The UI module 203 uses an arbitrary communication protocol to acquire device information or a log from the MFP 150.

An example of the communication protocol used by the device management module 204 is an HTTPS. The device management module 204 stores the device information acquired from the modules of the MFP 150 in a network device management table 300 or a log management table 301 of a database server service module 210 which will be described later. The device management module 204 also reads the device information from the network device management table 300 or the log management table 301 according to necessity.

The detection module 205 detects a problem that occurs in the MFP 150. The detection module 205 acquires device information or a log from the device management module 204 and detects a problem. The diagnosis module 206 diagnoses the problem detected by the detection module 205 and displays a diagnosis result on a UI via the UI module 203. At this time, the diagnosis module 206 acquires information required for diagnosis from a plurality of tables in a database server service module 210 which will be described later.

The treatment module 207 performs a treatment on the basis of the diagnosis result from the diagnosis module 206 and displays a treatment result on the UI via the UI module 203. The treatment which is performed by the treatment module 207 includes change of device settings and restart instruction for the MFP 150. The treatment module 207 instructs the MFP 150 connected to the application server 100 via the network 170 to change device settings or to restart via the network module 200. An example of the communication protocol used by the treatment module 207 is an HTTPS. The verification module 208 verifies whether the problem has been solved through the treatment of the treatment module 207 and displays a verification result on the UI via the UI module 203.

The database server service module 210 manages data and performs storage and reading of data in response to a request from another module. As long as it is accessed from the network device diagnosis application 202, the database server service module 210 may be provided in a device other than the application server 100. The database server service module 210 may be a database service in the cloud computing environment.

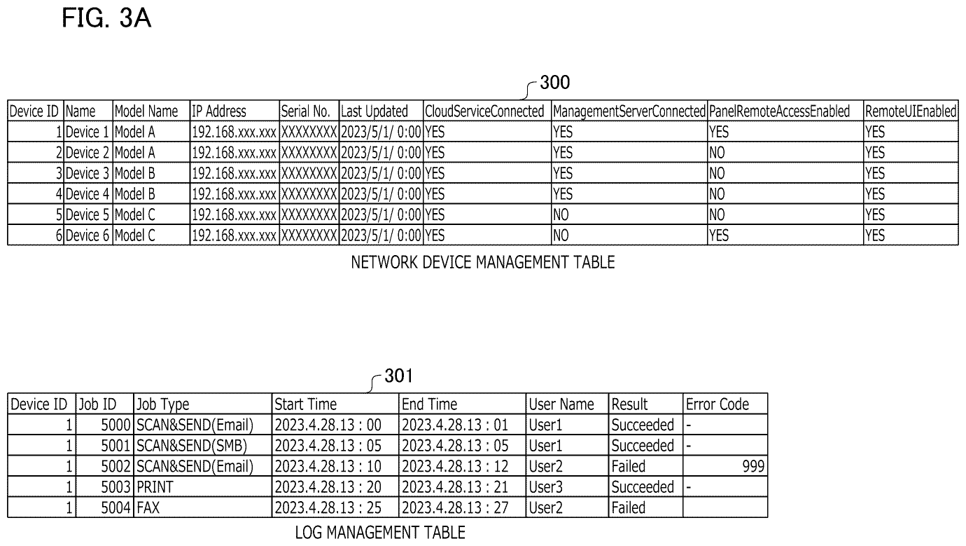

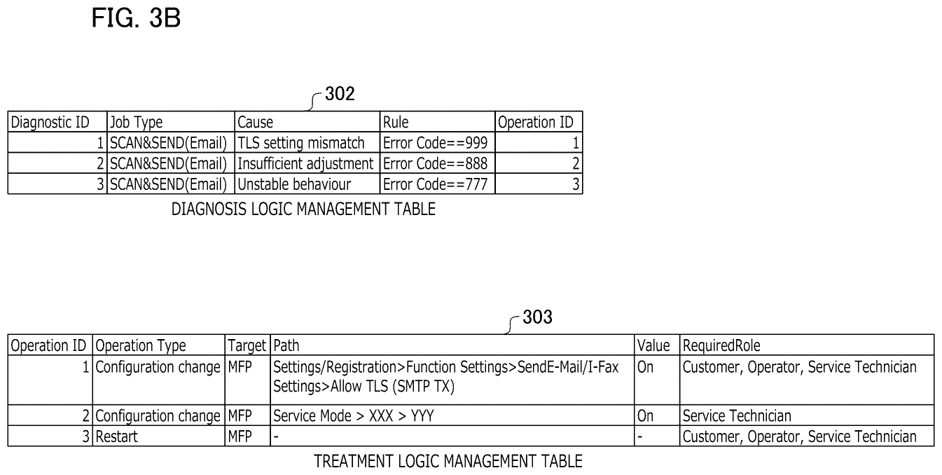

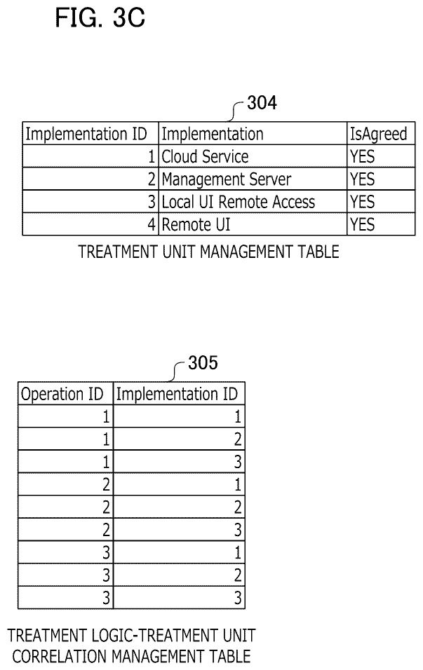

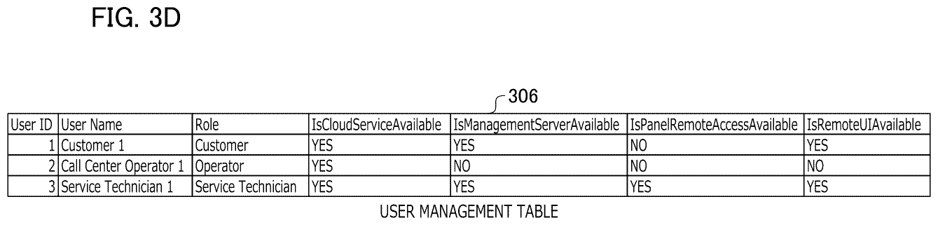

FIGS. 3A to 3D illustrate an example of a table structure in the database server service module 210. The table structures illustrated in FIGS. 3A to 3D are only examples. Therefore, the database server service module 210 may have a data structure other than the table structure illustrated in FIGS. 3A to 3D.

FIG. 3A is a diagram illustrating a network device management table and a log management table according to the first embodiment. The network device management table 300 is a table for managing device information on the MFP 150 managed by the network device diagnosis application 202. Examples of information managed in the network device management table 300 includes a network device identifier, a device name, a model name, an IP address, a serial number, and a last update date and time. In the network device management table 300, information indicating whether a cloud service is connected, whether a network device management application is connected, whether an operation unit is remotely accessible, whether an MFP-built-in management application is accessible, and the like is also managed. Here, the network device identifier is an identifier for uniquely identifying the MFP 150. The last update date and time is a last update date and time at which a record has been updated on the basis of the information acquired from the MFP 150.

The log management table 301 is a table in which the device management module 204 stores a log acquired by the MFP 150. Information managed in the log management table 301 includes, for example, a network device identifier, a job identifier, a job type, a job implementation start date and time, a job implementation end date and time, a job implementation user name, a job implementation result, and a job implementation result error code. Here, a job is a processing job such as printing, scanning and transmission, or facsimile which can be performed by a user on the MFP 150. The job identifier is an identifier for uniquely identifying a job.

FIG. 3B is a diagram illustrating a diagnosis logic management table and a treatment logic management table according to the first embodiment. The diagnosis logic management table 302 is a table in which diagnosis logics used for the diagnosis module 206 to diagnose a problem are managed. Information managed in the diagnosis logic management table 302 includes, for example, a diagnosis logic identifier, a job type, reason information, a diagnosis rule, and a treatment logic identifier. Here, the diagnosis logic identifier is an identifier for uniquely identifying a diagnosis logic. The treatment logic identifier is an identifier for uniquely identifying a treatment logic. The reason information is information indicating details which are considered to be a reason of the problem as a result of diagnosis. The diagnosis rule is information indicating a logic which is used for diagnosis. The diagnosis module 206 identifies a reason of the problem by determining whether it matches the diagnosis rule.

The treatment logic management table 303 is a table in which treatment logics used for the diagnosis module 206 to display a diagnosis result of a problem on a UI and to perform a treatment according to a user's instruction are managed. Information managed in the treatment logic management table 303 includes, for example, a treatment logic identifier, a treatment type, a treatment target, treatment details, and an access right.

Here, the treatment logic identifier is an identifier for uniquely identifying a treatment logic. The treatment type is information for classifying treatment details and includes, for example, change of device settings and restart. The treatment target is information on a target on which a treatment is performed and includes, for example, the MFP 150, a server, and a network device. The treatment details are information indicating specific treatment details and includes, for example, setting path information at the time of change of device settings and information of a value to be changed. The access right is information on a user's role information required to perform a treatment and includes, for example, role information of a user such as a customer manager, a call center operator, and a service technician.

FIG. 3C is a diagram illustrating a treatment unit management table and a treatment logic-treatment unit correlation management table according to the first embodiment. The treatment unit management table 304 is a table in which treatment unit used for the diagnosis module 206 to display a diagnosis result of a problem on a UI and to perform a treatment according to a user's instruction are managed. Information managed in the treatment unit management table 304 includes, for example, a treatment unit identifier, a treatment unit name, and use agreement information. Here, the treatment unit identifier is an identifier for uniquely identifying a treatment unit. The use agreement information is information indicating whether a user or an owner of the MFP 150 has agreed to use of the treatment unit.

The treatment logic-treatment unit correlation management table 305 is a table in which correlation information between treatment logics and treatment unit used for the diagnosis module 206 to display a diagnosis result of a problem on a UI and to perform a treatment according to a user's instruction is managed. Information managed in the treatment logic-treatment unit correlation management table 305 includes, for example, a treatment logic identifier and a treatment unit identifier. Here, the treatment logic identifier is an identifier for uniquely identifying a treatment logic. The treatment unit identifier is an identifier for uniquely identifying a treatment unit.

FIG. 3D is a diagram illustrating a user management table according to the first embodiment. The user management table 306 is a table in which user information used for the diagnosis module 206 to display a diagnosis result of a problem on a UI is managed. Information managed in the user management table 306 includes, for example, a user identifier, a user name, and role information. In the user management table 306, information indicating whether a cloud service is available, whether a network device management application is available, whether an operation unit is remotely accessible, or whether an MFP-built-in management application is accessible is also managed.

A software configuration of the client computer 120 will be described below. Modules constituting the client computer 120 are program modules which are present as files stored in the ROM 103 or the external memory 110. The modules constituting the client computer 120 are loaded to the RAM 102 and implemented by the OS or a module using modules included in the OS at the time of implementation.

The network module 220 performs network communication with the application server 100, the application server 140, and the MFP 150 using an arbitrary communication protocol. The web browser 221 transmits an HTTP request message via the network module 220 and receives and displays an HTTP response message. The web browser 221 performs an access of the client computer 120 to the application server 100, the application server 140, and the MFP 150. A printer driver 222 prepares a print job and transmits the print job to the MFP 150 via the network module 220. The printer driver 222 receives a print job implementation result from the MFP 150 via the network module 220 and displays the received print job implementation result.

A software configuration of the application server 140 will be described below. In the application server 140, a network device management application 232 and modules are present as files stored in the external memory 110. The network device management application 232 and the modules are program modules which are loaded to the RAM 102 and implemented by the OS or a module using modules included in the OS at the time of execution. The network device management application 232 is configured to be added to the HDD or the SSD of the external memory 110 via a CD-ROM which is not illustrated in the external memory 110 or the network 170. The external memory 110 may be provided on demand through virtualization technology in the cloud computing environment.

The network module 230 performs network communication with the client computer 120 or the MFP 150 using an arbitrary communication protocol.

A web server service module 231 provides a service of returning an HTTP response when an HTTP request is received from the web browser 221 of the client computer 120. An example of the HTTP response to be returned is a return of web page data stored in the external memory 110. The web server service module 231 may request the network device management application 232 to generate an HTTP response.

The network device management application 232 is an application for managing the MFP 150 connected to the application server 100 via the network 170. The network device management application 232 is mounted, for example, as a program for performing a process in response to a request to a web page provided by the web server service module 231. As described above, the network device management application 232 along with the web server service module 231 realizes a web application for managing the MFP 150.

A software configuration of the MFP 150 will be described below. In the MFP 150, various modules are present as files stored in the ROM 154 or the external memory 162, and are loaded to the RAM 153 at the time of implementation and are then implemented.

The network module 240 performs network communication with the application server 100, the client computer 120, and the application server 140 using an arbitrary communication protocol.

A web server service module 241 provides a service of returning an HTTP response when an HTTP request is received from the web browser 221 of the client computer 120. An example of the HTTP response to be returned is a return of web page data stored in the external memory 162. The web server service module 241 may request a setting management module 247 or a power supply management module 248 to generate an HTTP response.

An operation unit remote access service module 242 receives an image transmission request from the web browser 221 of the client computer 120 or an application which is not illustrated. Then, the operation unit remote access service module 242 provides a service of transmitting a UI image to be displayed on the operation unit 156 by the UI module 250 when the image transmission request is received.

A print module 243 receives a print job transmitted from the printer driver 222 of the client computer 120 via the network module 240 and performs the print job. The print module 243 prepares a log of a print job implementation result and transmits the prepared log to the log management module 246.

A scanning and transmission module 244 receives a scanning instruction from a user via the UI module 250 and generates and implements a scanning job and a transmission job of scan data. Here, for example, a protocol such as an E mail or a server message block (SMB) is used to transmit scan data. The scanning and transmission module 244 prepares logs of implementation results of the scanning job and the transmission job and transmits the prepared logs to the log management module 246.

A facsimile module 245 receives a facsimile job transmitted from a facsimile machine which is not illustrated, an MFP, or the like via the network module 240. Here, the received facsimile reception job is implemented as a print job via the print module 243 or is transmitted to another facsimile machine, MFP, or the like. The facsimile module 245 receives a facsimile transmission instruction from a user via the UI module 250 and generates and implements a facsimile transmission job. The facsimile module 245 prepares a log of an implementation result of the facsimile reception job and a log of an implementation result of the facsimile transmission job and transmits the prepared logs to the log management module 246.

The log management module 246 receives a log acquisition request from the device management module 204 of the application server 100 via the network module 240 and returns the logs of job implementation results.

A setting management module 247 is a module for managing device settings of the MFP 150. The setting management module 247 receives settings confirmation and change instructions from a user via the UI module 250 and performs return and change of device settings of the MFP 150. The setting management module 247 receives setting confirmation and change instructions from the treatment module 207 of the application server 100 and the network device management application 232 of the application server 140 via the network module 240. Then, the setting management module 247 performs return and change of device settings of the MFP 150 in accordance with the received setting confirmation and change instructions.

A power supply management module 248 is a module for managing a power supply state of the MFP 150. The power supply management module 248 receives a power supply turning-off or restarting instruction from a user via the UI module 250 and performs power supply turning-off or restarting of the MFP 150. The power supply management module 248 receives a power supply turning-off or restarting instruction from the treatment module 207 of the application server 100 and the network device management application 232 of the application server 140 via the network module 240. Then, the power supply management module 248 performs power supply turning-off or restarting of the MFP 150 in accordance with the received power supply turning-off or restarting instruction.

An MFP-built-in management application 249 is constituted, for example, by the setting management module 247 and the power supply management module 248. The MFP-built-in management application 249 is mounted, for example, as a program for performing processes in response to a request to the web page provided by the web server service module 241. As described above, the MFP-built-in management application 249 along with the web server service module 241 is built in the MFP 150 and realizes a web application for managing the MFP 150.

A UI module 250 performs drawing of a UI displayed on the operation unit 156 of the MFP 150 and receiving of a user input value input through a user's operation of the UI on the operation unit 156.

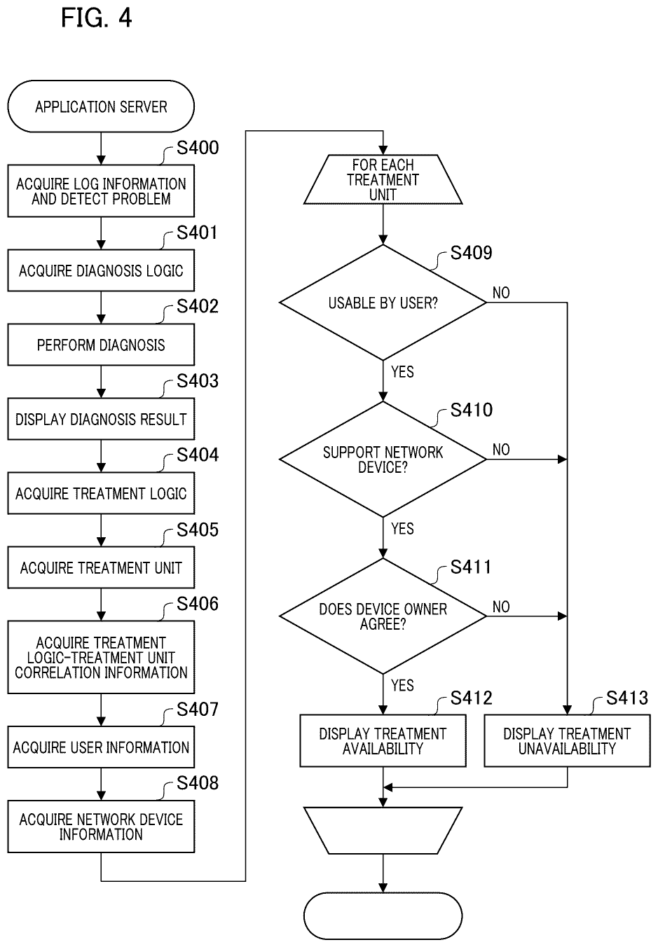

An operation that is performed by the application server 100 when the application server 100 detects and diagnoses a problem occurring in the MFP 150 and displays an available treatment unit on the basis of the diagnosis result will be described below with reference to FIG. 4. FIG. 4 is a flowchart illustrating a process flow at the time of determining and displaying a remote treatment unit according to the first embodiment.

In Step S400, the detection module 205 of the application server 100 acquires log information of the MFP 150 from the log management table 301 of the database server service module 210 via the device management module 204. Then, the detection module 205 detects a problem occurring in the MFP 150 on the basis of the acquired log information.

In Step S401, the diagnosis module 206 acquires a diagnosis logic from the diagnosis logic management table 302 of the database server service module 210.

In Step S402, the diagnosis module 206 performs diagnosis using the diagnosis logic acquired in Step S401 with regard to the problem detected by the detection module 205 in Step S400. For example, in the first embodiment, the diagnosis module 206 can ascertain that an error occurs in scanning and transmission of an electronic mail and an error code is 999 from the log information of the MFP 150 and diagnose that there is a problem in TLS settings using the diagnosis logic.

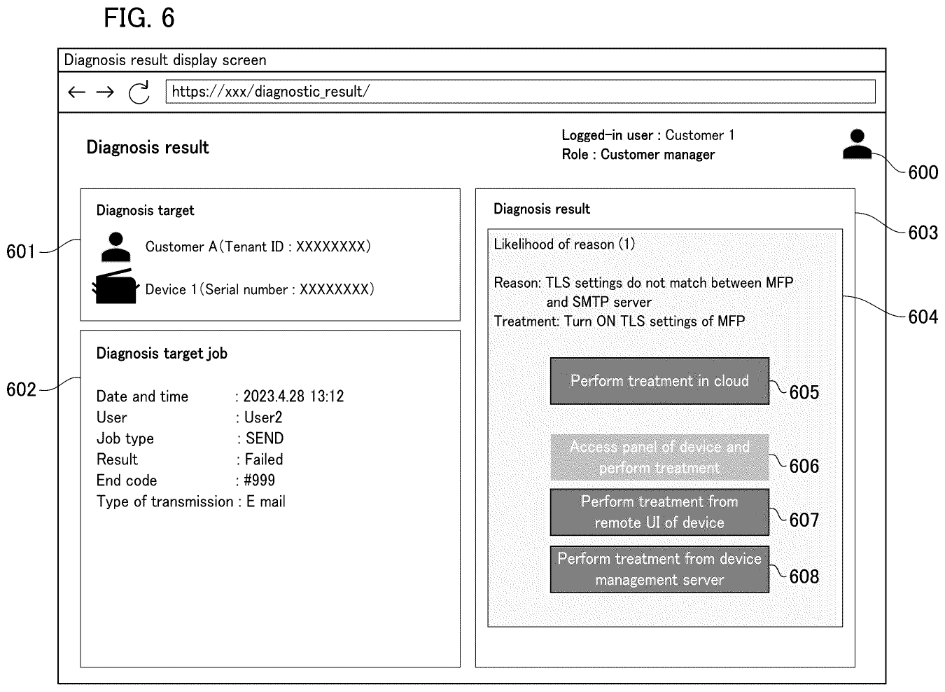

In Step S403, the diagnosis module 206 displays the diagnosis result on the UI via the UI module 203. When a reason of the problem can be uniquely identified as the diagnosis result from the diagnosis module 206, only one reason is displayed. On the other hand, when a reason of the problem cannot be uniquely identified as the diagnosis result from the diagnosis module 206, a plurality of possible reasons are displayed. An example of a diagnosis result display screen will be described later with reference to FIGS. 6, 7, and 8.

In Step S404, the diagnosis module 206 acquires a treatment logic from the treatment logic management table 303 of the database server service module 210.

In Step S405, the diagnosis module 206 acquires a treatment unit from the treatment unit management table 304 of the database server service module 210. Here, the treatment unit acquired by the diagnosis module 206 includes, for example, use agreement information. The use agreement information is information indicating whether a user or an owner of the MFP 150 has agreed to use of the treatment unit. The user agreement information is information in which a user selection result on a UI displayed by the UI module 203 of the network device diagnosis application 202 is reflected.

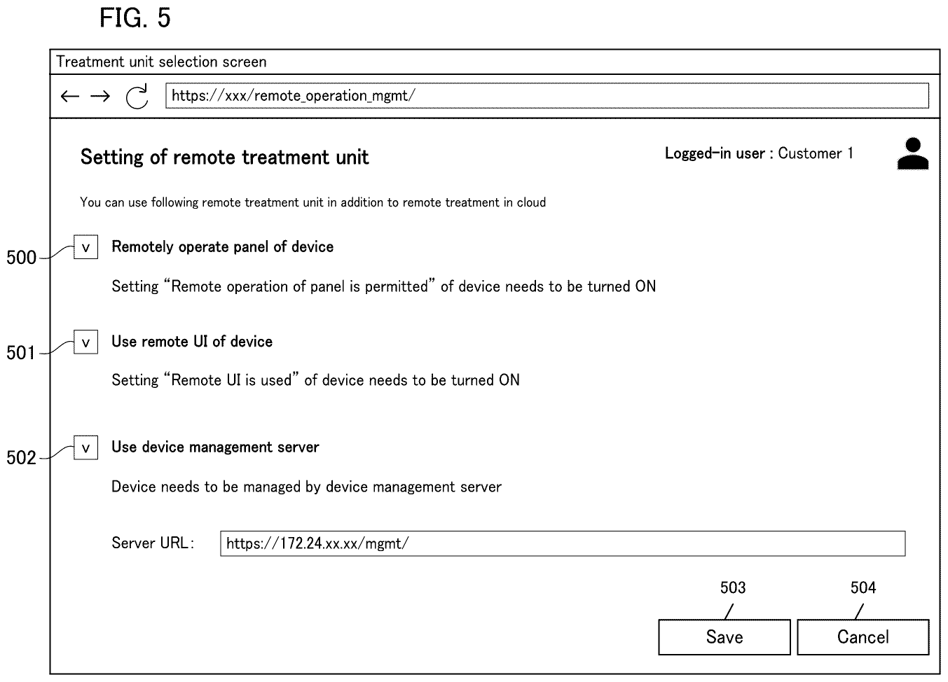

FIG. 5 is a diagram illustrating an example of a treatment unit selection screen according to the first embodiment. FIG. 5 illustrates an example of a treatment unit selection screen which is displayed by the UI module 203 of the network device diagnosis application 202. The treatment unit selection screen is configured to allow a user to select or set whether the user agrees to use of each treatment unit or not.

An operation unit remote accessibility selection part 500 enables selection of whether to use an operation unit remote access service provided by the operation unit remote access service module 242 of the MFP 150 as a treatment unit. An MFP-built-in management application accessibility selection part 501 enables selection of whether to use the MFP-built-in management application 249 of the MFP 150 as a treatment unit. A network device management application usability selection part 502 enables selection of whether to use the network device management application 232 of the application server 140 as a treatment unit.

When a save button 503 is clicked, the UI module 203 acquires details selected on the UI and updates details of the treatment unit management table 304 of the database server service module 210 via the diagnosis module 206 with overwriting. When a cancel button 504 is clicked, details set on the UI are discarded and a user input is cancelled.

Referring back to FIG. 4, in Step S406, the diagnosis module 206 acquires treatment logic-treatment unit correlation information from the treatment logic-treatment unit correlation management table 305 of the database server service module 210. The diagnosis module 206 identifies a treatment logic and a treatment unit for realizing the treatment logic for each reason on the basis of the diagnosis result in Step S402. At this time, the diagnosis module 206 uses the treatment logic, the treatment unit, and the treatment logic-treatment unit correlation information which are acquired in Steps S404 to S406.

In Step S407, the diagnosis module 206 acquires user information from the user management table 306 of the database server service module 210

In Step S408, the diagnosis module 206 acquires network device information from the network device management table 300 of the database server service module 210 via the device management module 204. The network device information acquire by the diagnosis module 206 includes, for example, information indicating whether a cloud service is connected, whether the network device management application is connected, operation unit remote accessibility, and MFP-built-in management application accessibility.

Hereinafter, the processes of Steps S409 to S413 are performed for each treatment unit. In Step S409, the diagnosis module 206 determines whether the corresponding treatment unit can be used with a role of a user who logs in to the network device diagnosis application 202 using the user information acquired in Step S407. The diagnosis module 206 causes the process flow to proceed to Step S410 when it is determined that the treatment unit can be used and causes the process flow to proceed to Step S413 when it is determined that the treatment unit cannot be used.

In Step S410, the diagnosis module 206 determines whether the treatment unit is supported by the MFP 150 using the network device information acquired in Step S408. The diagnosis module 206 causes the process flow to proceed to Step S411 when it is determined that the treatment unit is supported and causes the process flow to proceed to Step S413 when it is determined that the treatment unit is not supported.

In Step S411, the diagnosis module 206 determines whether use of the treatment unit has been agreed to using the use agreement information included in the treatment unit acquired in Step S405. The diagnosis module 206 causes the process flow to proceed to Step S412 when it is determined that use has been agreed to and causes the process flow to proceed to Step S413 when it is determined that use has not been agreed to.

In Step S412, the diagnosis module 206 displays information indicating that the treatment unit is usable on the diagnosis result display screen on the UI via the UI module 203. On the other hand, in Step S413, the diagnosis module 206 displays information indicating that the treatment unit is not usable on the diagnosis result display screen on the UI via the UI module 203.

FIGS. 6, 7, and 8 illustrate examples of the diagnosis result display screen that is displayed via the UI module 203 by the diagnosis module 206.

FIG. 6 illustrates an example of the diagnosis result display screen (a customer manager) according to the first embodiment. The screen example illustrated in FIG. 6 is an example of the diagnosis result display screen when a user with a role of a customer manager logs in to the network device diagnosis application 202.

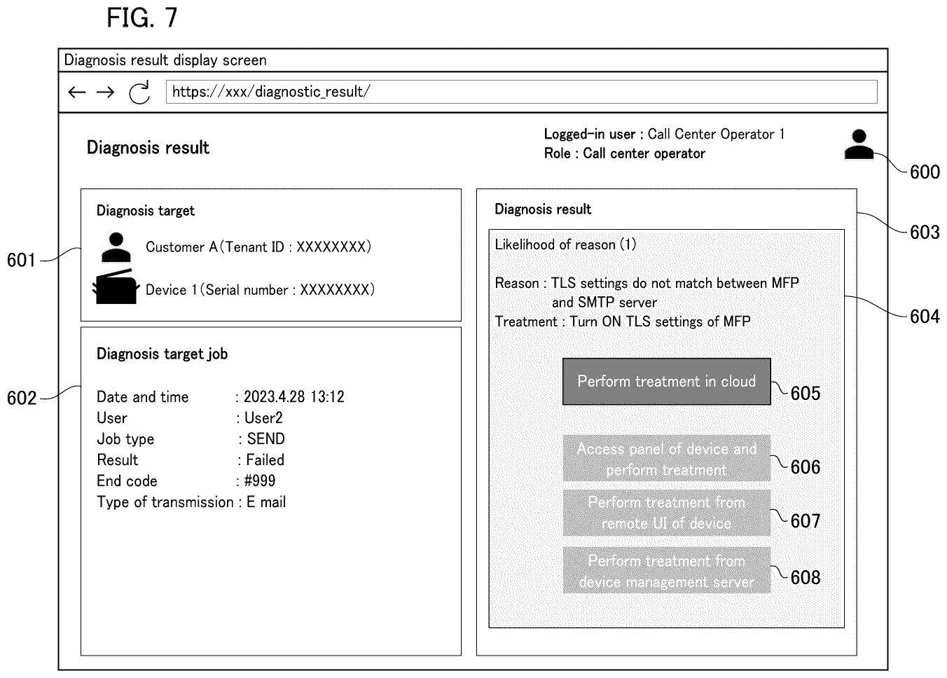

FIG. 7 illustrates an example of the diagnosis result display screen (a call center operator) according to the first embodiment. The screen example illustrated in FIG. 7 is an example of the diagnosis result display screen when a user with a role of a call center operator logs in to the network device diagnosis application 202.

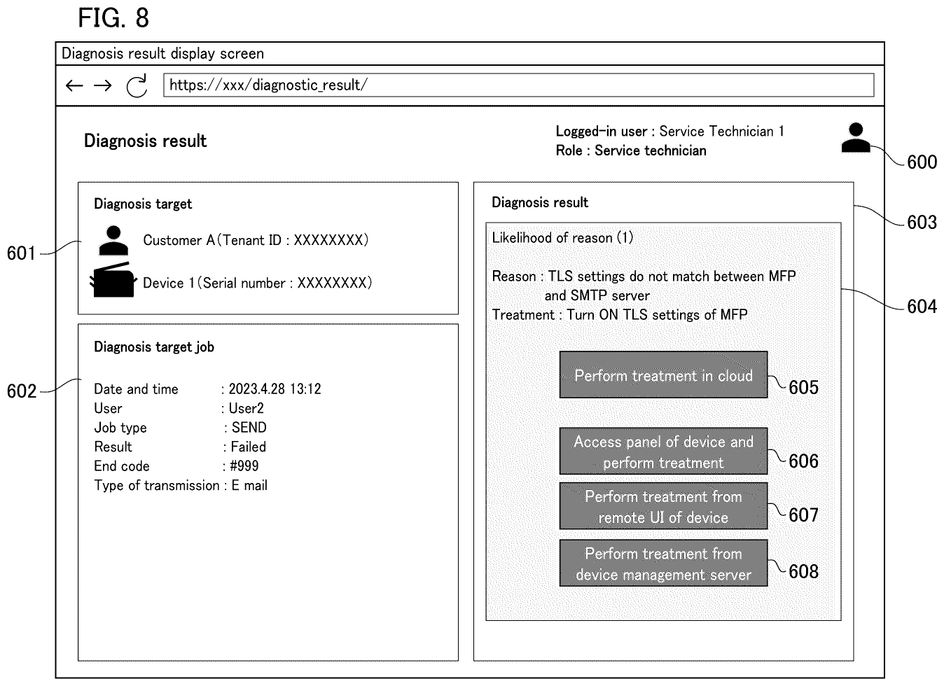

FIG. 8 illustrates an example of the diagnosis result display screen (a service technician) according to the first embodiment. The screen example illustrated in FIG. 8 is an example of the diagnosis result display screen when a user with a role of a service technician logs in to the network device diagnosis application 202.

Information of a user who logs in to the network device diagnosis application 202 is displayed in a login user information display part 600. Information of the MFP 150 to be diagnosed and a customer who owns the MFP 150 is displayed in a diagnosis target display part 601. Log information of the detected MFP 150 acquired by the detection module 205 in Step S400 is displayed as a diagnosis target job in a diagnosis target job display part 602. The diagnosis result from the diagnosis module 206 in Step S402 is displayed in a diagnosis result display part 603.

One or more sets of a reason and a treatment identified as the diagnosis result from the diagnosis module 206 in Step S402 are displayed in a diagnosis result reason and treatment display part 604. When a reason of a problem can be uniquely identified as the diagnosis result from the diagnosis module 206, only one set of a reason and a treatment is displayed in the diagnosis result reason and treatment display part 604. On the other hand, when a reason of a problem cannot be uniquely identified, a plurality of possible sets of a reason and a treatment are displayed in the diagnosis result reason and treatment display part 604.

The screen examples illustrated in FIGS. 6, 7, and 8 are examples in which a reason of a problem can be uniquely identified and only one set of a reason and a treatment is displayed. In FIGS. 6, 7, and 8, a cloud service treatment button 605, an operation unit remote access treatment button 606, an MFP-built-in management application treatment button 607, and a network device management application treatment button 608 are illustrated.

When these four buttons are clicked, the screen can be switched to screens in which treatments are performed using the treatment unit. All the four buttons are displayed to be valid when it is determined in Step S412 that the diagnosis module 206 can use the treatment unit. On the other hand, all the four buttons are displayed to be invalid when it is determined in Step S413 that the diagnosis module 206 cannot use the treatment unit. Whether each button is displayed to be valid or invalid is determined according to a role of a user who logs in to the network device diagnosis application 202. In the screen example illustrated in FIG. 6, the cloud service treatment button 605, the MFP-built-in management application treatment button 607, and the network device management application treatment button 608 are displayed to be valid, and the operation unit remote access treatment button 606 is displayed to be invalid. In the screen example illustrated in FIG. 7, the cloud service treatment button 605 is displayed to be valid, and the operation unit remote access treatment button 606, the MFP-built-in management application treatment button 607, and the network device management application treatment button 608 are displayed to be invalid. In the screen example illustrated in FIG. 8, all of the cloud service treatment button 605, the operation unit remote access treatment button 606, the MFP-built-in management application treatment button 607, and the network device management application treatment button 608 are displayed to be valid.

Through the aforementioned process flow, the application server 100 ascertains whether the treatment unit is accessible, whether a device owner has agreed to use of the treatment unit, whether the treatment unit is supported by the device, and the like when a problem occurring in the MFP 150 is diagnosed and the available treatment unit is displayed on the basis of the diagnosis result. Accordingly, the application server 100 can determine and presents a remote treatment unit which is optimal for a user on the basis of whether the treatment unit is accessible, whether a device owner has agreed to use of the treatment unit, whether the treatment unit is supported by the device, and the like and guide the user.

### Second Embodiment

When a treatment for restoring a network device from a problem is implemented, it may be intended to implement the same treatment on other network devices as well as the corresponding network device. An example of such a case is a case in which the same problem occurs simultaneously in a plurality of network devices. An example of such a case is a case in which a problem has not occurred yet in network devices other than the corresponding network device, but the treatment is implemented as a preventive treatment due to a likelihood that a problem will occur in the future. In these case, a user has to be guided to a treatment unit that can treat the plurality of network devices in batch.

When verification of whether a problem has been solved by a treatment after the treatment for restoring a network device from the problem has been implemented, some of a plurality of treatment unit may include a verification unit after the treatment has been implemented and some thereof may not include a verification unit. When a user selects a treatment unit including a verification unit, verification can be smoothly performed after the treatment has been implemented. However, when a user selects a treatment unit not including a verification unit, it is necessary to implement a verification unit other than the treatment unit in order to perform verification after the treatment has been implemented. In this case, the user has to be smoothly guided to a verification unit other than the treatment unit.

Therefore, in a second embodiment, an example in which whether a treatment unit is implementable is determined and displayed on the basis of whether the treatment unit can treat a plurality of network devices in a batch when a treatment for restoring a network device from a problem is implemented will be described. In the second embodiment, an example in which guidance to a verification unit result of a treatment unit is displayed when the treatment unit does not include a verification unit will also be described.

A hardware configuration and a software configuration of a network device diagnosis system according to the second embodiment are the same as the configurations illustrated in FIGS. 1 and 2 according to the first embodiment, and thus description thereof will be omitted.

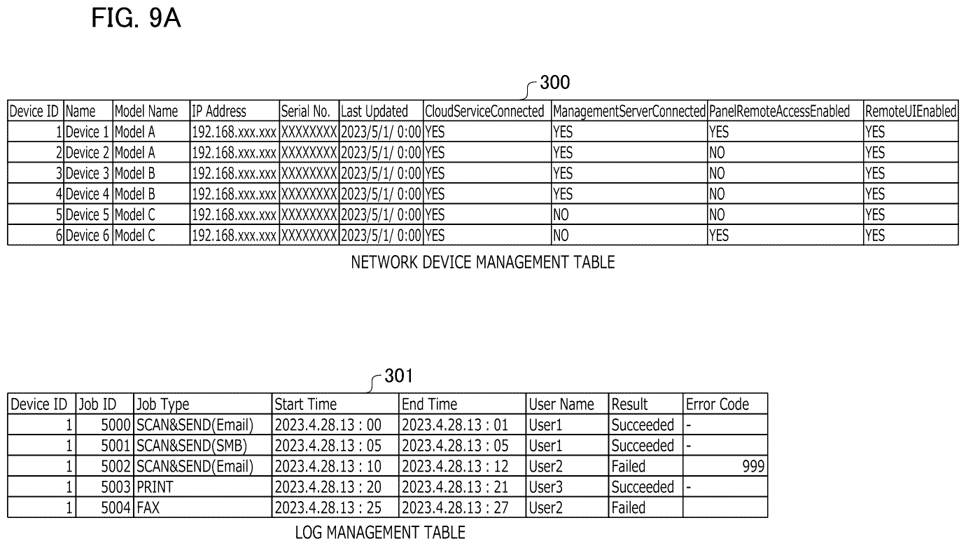

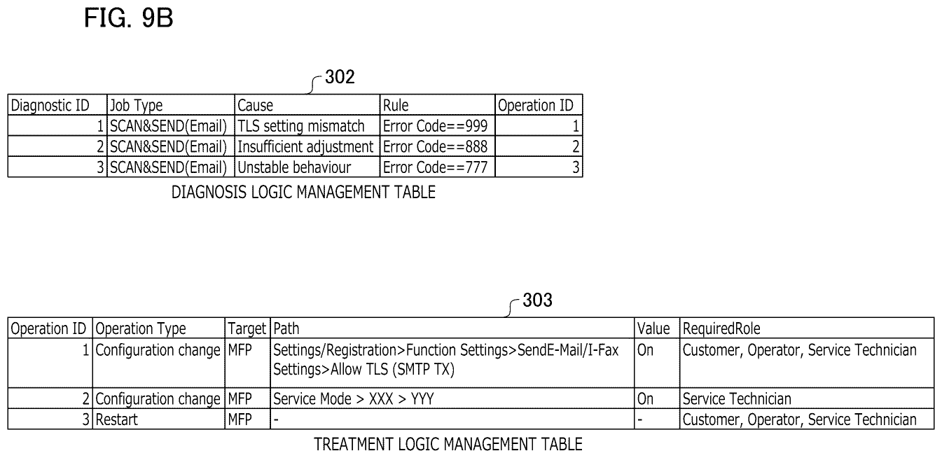

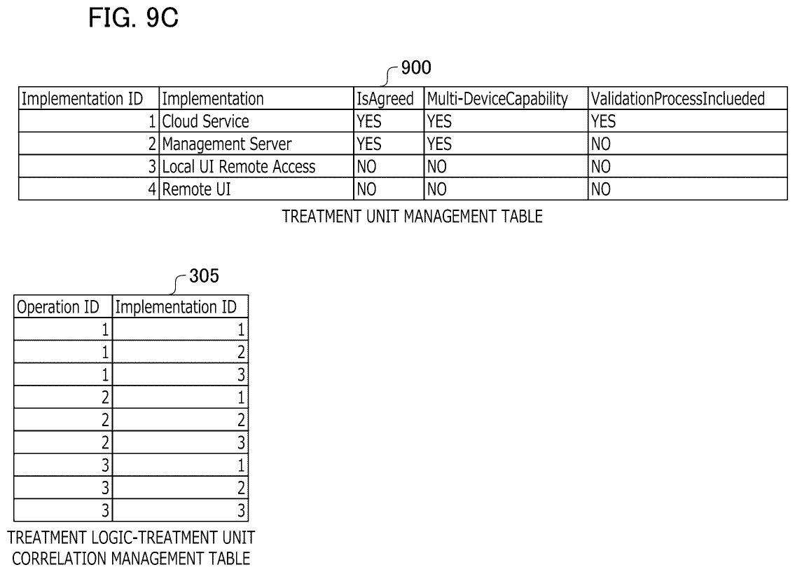

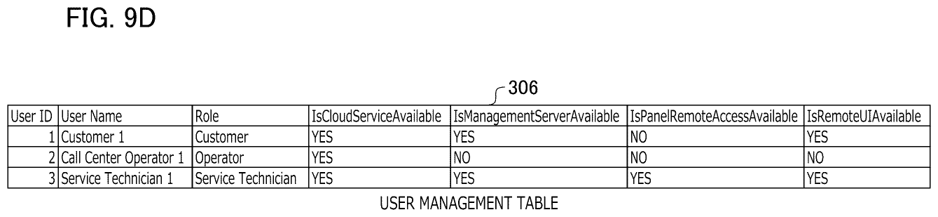

FIGS. 9A to 9D illustrate examples of table structures in a database server service module 210 of an application server 100. The table structures illustrated in FIGS. 9A to 9D are only examples. Accordingly, the database server service module 210 may have a table structure other than the table structures illustrated in FIGS. 9A to 9D.

FIG. 9A is a diagram illustrating a network device management table and a log management table according to the second embodiment. FIG. 9B is a diagram illustrating a diagnosis logic management table and a treatment logic management table according to the second embodiment. FIG. 9C is a diagram illustrating a treatment unit management table and a treatment logic-treatment unit correlation management table according to the second embodiment. FIG. 9D is a diagram illustrating a user management table according to the second embodiment. The network device management table 300 and the log management table 301 illustrated in FIG. 9A and the diagnosis logic management table 302 and the treatment logic management table 303 illustrated in FIG. 9B are the same as described above in the first embodiment. The treatment logic-treatment unit correlation management table 305 illustrated in FIG. 9C and the user management table 306 illustrated in FIG. 9D are the same as described above in the first embodiment. Accordingly, description of the tables in the second embodiment will be omitted.

A treatment unit management table 900 is a table for managing treatment unit which are used for the diagnosis module 206 to display a diagnosis result of a problem on a UI and to implement a treatment according to a user's instruction. Information managed in the treatment unit management table 900 includes, for example, multi-device batch treatment possibility information and verification unit inclusion information in addition to a treatment unit identifier, a treatment unit name, and use agreement information which have been described above in description of the treatment unit management table 304 of the first embodiment. Here, the multi-device batch treatment possibility information is information indicating whether the corresponding treatment unit supports batch treatment of a plurality of MFPs 150. The verification unit inclusion information is information indicating whether the corresponding treatment unit includes a verification unit after treatment.

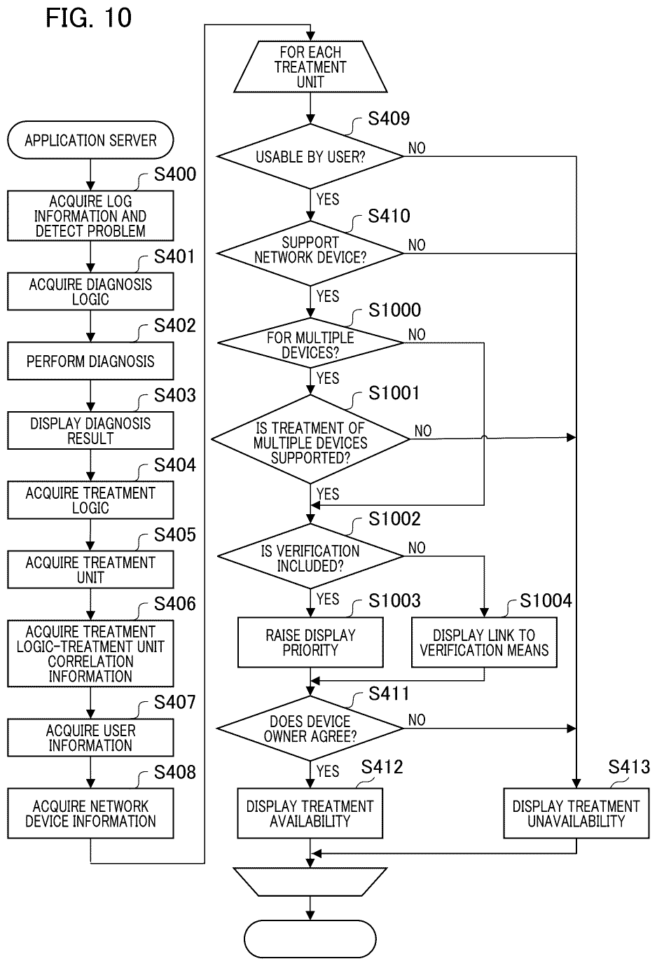

An operation that is performed by the application server 100 when the application server 100 detects and diagnoses a problem occurring in the MFP 150 and displays available treatment unit on the basis of the diagnosis result will be described below with reference to FIG. 10. FIG. 10 is a flowchart illustrating a process flow at the time of determining and displaying a remote treatment unit according to the second embodiment. Steps S400 to S410 and Steps S411 to S413 illustrated in FIG. 10 are the same as the steps illustrated in FIG. 4, and thus description thereof will be omitted.

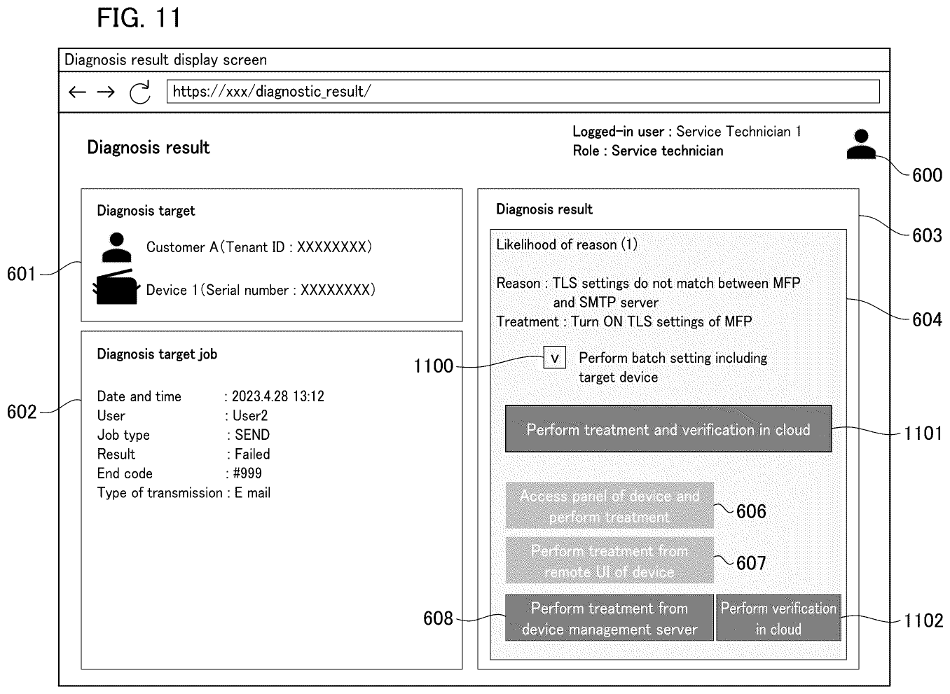

In Step S1000, the diagnosis module 206 of the application server 100 determines whether a user wants batch treatment of a plurality of MFPs 150. The diagnosis module 206 performs determination of whether a user wants batch treatment of a plurality of MFPs 150, for example, on the basis of results selected by the user on the UI of a multiple network devices batch treatment selection part 1100 or the like illustrated in FIG. 11 which will be described later. The diagnosis module 206 causes the process flow to proceed to Step S1001 when it is determined that the user wants batch treatment of a plurality of MFPs 150 and causes the process flow to proceed to Step S1002 when it is determined that the user does not want batch treatment of a plurality of MFPs 150.

In Step S1001, the diagnosis module 206 determines whether the corresponding treatment unit supports batch treatment of a plurality of MFPs 150 using the multi-device batch treatment possibility information included in the treatment unit acquired in Step S405. The diagnosis module 206 causes the process flow to proceed to Step S1002 when it is determined that the treatment unit supports batch treatment of a plurality of MFPs 150 and causes the process flow to proceed to Step S413 when it is determined that the treatment unit does not support batch treatment of a plurality of MFPs 150.

In Step S1002, the diagnosis module 206 determines whether the treatment unit includes a verification unit after treatment using verification unit inclusion information included in the treatment unit acquired in Step S405. The diagnosis module 206 causes the process flow to proceed to Step S1003 when it is determined that the treatment unit includes a verification unit after treatment and causes the process flow to proceed to Step S1004 when it is determined that the treatment unit does not include a verification unit after treatment.

In Step S1003, the diagnosis module 206 performs a process of raising a relative display priority of the treatment unit with respect to other treatment unit at the time of display of the UI. Here, the process of raising a display priority is, for example, a process of displaying a treatment unit including a verification unit at a higher position than other treatment unit such that a user can preferentially easily select. The process of raising a display priority is, for example, a process of displaying a mark indicating that it is preferable to preferentially select the corresponding treatment unit in the vicinity of the treatment unit. The diagnosis module 206 causes the process flow to proceed to Step S411 after the process of Step S1003 has been performed.

In Step S1004, the diagnosis module 206 displays a link to a verification unit along with the treatment unit on the UI. The diagnosis module 206 causes the process flow to proceed to Step S411 after the process of Step S1004 has been performed.

FIG. 11 illustrates an example of a diagnosis result display screen (a service technician) according to the second embodiment. FIG. 11 illustrates an example of a diagnosis result display screen which is displayed on the UI via the UI module 203 by the diagnosis module 206. Elements other than a multiple network devices batch treatment selection part 1100, a cloud service treatment verification button 1101, and a cloud service verification button 1102 illustrated in FIG. 11 are the same as illustrated in FIGS. 6, 7, and 8, and thus description thereof will be omitted.

The multiple network devices batch treatment selection part 1100 enables selection of whether a user wants batch treatment of a plurality of MFPs 150. The determination result from the diagnosis module 206 in Step S1000 varies according to the result of selection using the multiple network devices batch treatment selection part 1100.

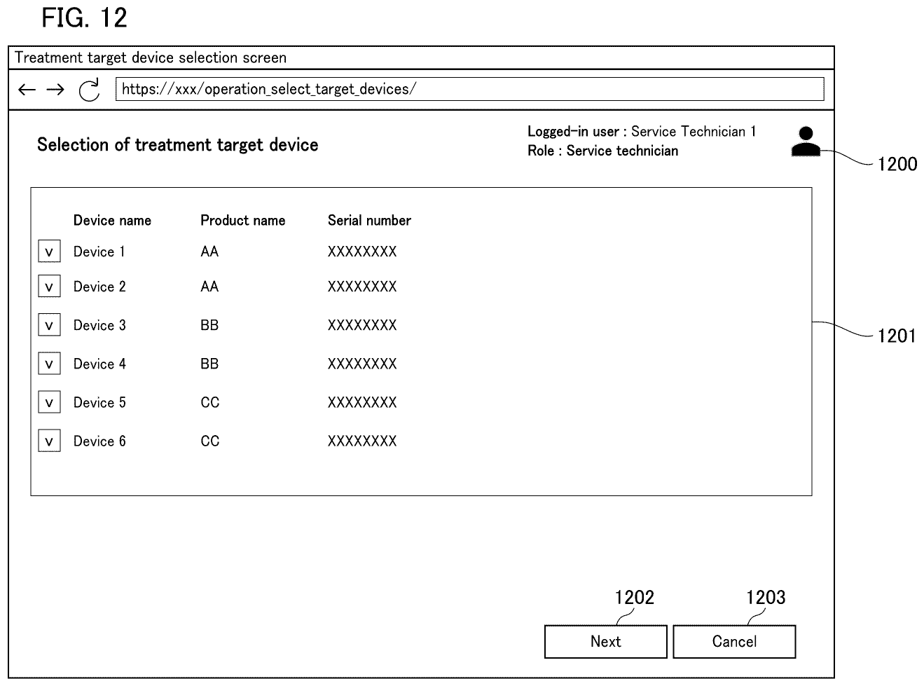

When the cloud service treatment verification button 1101 is clicked, the screen transitions to a screen in which the network device diagnosis application 202 performs batch treatment of a plurality of MFPs 150. An example of the screen in which batch treatment of a plurality of MFPs 150 is performed is illustrated in FIG. 12 which will be described later. In the second embodiment, the network device diagnosis application 202 includes both a treatment unit and a verification unit. Accordingly, in the screen example, the display priority is raised by the diagnosis module 206 in Step S1003, and thus the corresponding treatment unit is displayed at a highest position out of the treatment unit.

When the cloud service verification button 1102 is clicked, the screen transitions to a screen in which verification is performed by the network device diagnosis application 202. In the second embodiment, the network device management application 232 of the application server 140 does not include a verification unit after treatment. Accordingly, in the screen example, the cloud service verification button 1102 is displayed beside the network device management application treatment button 608.

FIG. 12 is a diagram illustrating an example of a treatment target device selection screen according to the second embodiment. FIG. 12 illustrates an example of a screen that is displayed after the cloud service treatment verification button 1101 illustrated in FIG. 11 has been clicked. The screen example illustrated in FIG. 12 is an example of a screen in which batch treatment of a plurality of MFPs 150 is performed by the network device diagnosis application 202.

Information of a user who logs in to the network device diagnosis application 202 is displayed in a login user information display part 1200. Information of the MFPs 150 which are managed by the network device diagnosis application 202 is displayed in a multiple network devices selection part 1201. The multiple network devices selection part 1201 enables a user to select a plurality of MFPs 150 to be batch treated using a check box. Then, when a next button 1202 is clicked, the screen transitions to a screen in which batch treatment of a plurality of MFPs 150 selected by the multiple network devices selection part 1201 is performed. When a cancel button 1203 is clicked, details set on the UI are discarded, and a user input is cancelled.

Through the aforementioned processes, it is possible to determine and display whether a treatment unit is implementable on the basis of whether the treatment unit can perform batch treatment of a plurality of network devices when a treatment for restoring a network device from a problem is implemented. When the treatment unit does not include a verification unit after treatment, it is also possible to display guidance to a verification unit other than the treatment unit.

### OTHER EMBODIMENTS

The present invention may be realized as processing in which a program for realizing one or more functions of the aforementioned embodiments is supplied to a system or a device via a network or a recording medium and one or more processors of a computer in the system or the device read and execute the program. The present invention may be realized as a circuit for realizing one or more functions, for example, an application-specific integrated circuit (ASIC).

Embodiments of the present invention can also be realized by a computer of a system or apparatus that reads out and implements computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and implement the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-5674, filed Jan. 17, 2024, which is hereby incorporated by reference wherein in its entirety.

What is claimed is:

1. A device management system that diagnoses a problem associated with a network device on the basis of information acquired from the network device and displays a treatment for the problem on the basis of a diagnosis result, the device management system comprising:
a treatment information acquiring unit configured to acquire treatment information indicating information on the treatment on the basis of the diagnosis result for each of a plurality of treatments;
an accessibility information acquiring unit configured to acquire accessibility information indicating whether a user is able to access the treatment;
a supportability information acquiring unit configured to acquire supportability information indicating whether the network device is supported by the treatment;
a treatment implementability determining unit configured to determine whether the treatment is implementable on the basis of at least one of the accessibility information and the supportability information; and
a display unit configured to display the treatment when it is determined that the treatment is implementable.

2. The device management system according to claim 1, further comprising a use agreement information acquiring unit configured to acquire use agreement information indicating whether an owner of the network device agrees to use of the treatment,
wherein the treatment implementability determining unit determines whether the treatment is implementable on the basis of the use agreement information.

3. The device management system according to claim 1 or 2, further comprising a treatment unit configured to transmit an instruction for at least one of change of device settings and restart based on the diagnosis result to the network device via a network in order to cope with the problem associated with the network device as one of the plurality of treatments.

4. The device management system according to claim 1 or 2, wherein one of the plurality of treatments includes remote access to an operation unit of the network device in order to cope with the problem associated with the network device.

5. The device management system according to claim 1 or 2, wherein the supportability information acquiring unit further acquires multi-device treatability information indicating whether the treatment is able to be simultaneously implemented with a plurality of network devices,
wherein the treatment implementability determining unit determines whether the treatment is implementable on the basis of the multi-device treatability information.

6. The device management system according to claim 1 or 2, wherein the display unit determines whether the treatment includes a unit for verification after implementation of the treatment has been completed and preferentially displays the treatment when it is determined that the treatment includes the unit for verification after implementation of the treatment has been completed.

7. The device management system according to claim 1 or 2, wherein the display unit determines whether the treatment includes a unit for verification after implementation of the treatment has been completed and displays a unit for verification after implementation of the treatment has been completed along with the treatment when it is determined that the treatment does not include a unit for verification after implementation of the treatment has been completed.

8. A method of diagnosing a problem associated with a network device on the basis of information acquired from the network device and displaying a treatment for the problem on the basis of a diagnosis result, the method comprising:
acquiring treatment information indicating information on the treatment on the basis of the diagnosis result for each of a plurality of treatments;
acquiring accessibility information indicating whether a user is able to access the treatment;
acquiring supportability information indicating whether the network device is supported by the treatment;
determining whether the treatment is implementable on the basis of at least one of the accessibility information and the supportability information; and
displaying the treatment when it is determined that the treatment is implementable.
